(19) United States
(12) Patent Application Publication
(10) Pub. No.: US 2015/0294600 A1
(43) Pub. Date: Oct. 15, 2015

(54) ENCRYPTION AND DECRYPTION DEVICE AND METHOD

(71) Applicant: Robert TINGWALL, Massapequa Park, NY (US)

(72) Inventor: Robert TINGWALL, Massapequa Park, NY (US)

(21) Appl. No.: 14/684,319

(22) Filed: Apr. 10, 2015

Related U.S. Application Data
(60) Provisional application No. 61/977,926, filed on Apr. 10, 2014.

(51) Int. Cl. G09C 1/04

(52) U.S. Cl. CPC G09C 1/04

(57) ABSTRACT

An encryption device and method for creating, storing and retrieving passwords is provided. The encryption device may include a sleeve for receiving a slidable card, both cooperative so that the sleeve and the slidable card are movable relative to each other. The sleeve forms an index window and an encryption window through which a portion of a set of index symbols and a portion of a set of encryption symbols imprinted on the slidable card may be respectively read. As the slidable card slides to display a new portion of the set of index symbols through the index window, a new portion of the set of encryption symbols become readable through the encryption window. The method embodying the encryption device utilizes a skip sequence number formula, a hint, and/or at least one unforgettable number to create a plurality of unique, encrypted passwords that can be similarly retrieved/decrypted with the encryption device and method when needed.

### CROSS-REFERENCE TO RELATED APPLICATION

This application claims the benefit of priority of U.S. provisional application No. 61/977,926, filed 10 Apr. 2014, the contents of which are herein incorporated by reference.

### BACKGROUND OF THE INVENTION

The present invention relates to encryption systems and, more particularly, to a device and method for encrypting and decrypting a string of symbols, such as alphanumeric characters, for creating, storing and retrieving passwords.

With the advent of complicated passwords required by internet web sites, the necessity of a secure means of creating, storing and retrieving such passwords has become a must. Conventional means, such as password programs, electronic storage and retrieval devices, or traditional pen and paper methods have problematic flaws. The password programs are usually dependent on a person's home computer and not available on work or remote computers, and can be remotely hacked so as to frustrate their very purpose. Electronic devices can also be hacked and are prone to become inoperable due to physical damage or lack of a power source. They can also be misplaced and are relatively bulky. Traditional pen and paper methods require notebooks or other paper records that can be destroyed or compromised so as to prevent retrieval of the stored passwords; or they could be lost or stolen, and so easily misused if found by the unscrupulous.

As can be seen, there is a need for a device and method for encrypting and decrypting a string of symbols, such as alphanumeric characters, for creating, storing and retrieving passwords, wherein the number of stored passwords are unlimited yet uniquely encrypted, and wherein the device never needs batteries, fits in your wallet, and can be easily replaced if lost.

### SUMMARY OF THE INVENTION

In one aspect of the present invention, a method for encrypting and retrieving a password having at least one code symbol, includes providing a set of index symbols and a set of encryption symbols, wherein each set occupies a plurality of columns, and wherein each set includes at least alphanumeric symbols; aligning the set of index symbols and the set of encryption symbols in shared columns, wherein the set of index symbols forms one row, and the set of encryption symbols forms a plurality of countable rows; identifying a hint sequence having a plurality of alphanumeric symbols; providing an unforgettable number having a predetermined number of digits; locating a first column of the set of index symbols matching the alphanumeric symbol of a first symbol of the hint sequence; and identifying as a first code symbol a first symbol from the set of encryption symbols found in the first column and the countable row referenced by counting corresponding to a first digit of the unforgettable number.

In another embodiment of the present invention, an encryption device for encrypting and retrieving a password having at least one code symbol includes a slidable card providing a set of index symbols; and a set of encryption symbols, wherein each set occupies a plurality of shared columns so that the set of index symbols forms one row, and the set of encryption symbols forms a plurality of countable rows; and a sleeve dimensioned and adapted to slidably receive the slidable card, wherein the sleeve forms an index window and an encryption window for reading one shared column providing one index symbol and a portion of the plurality of encryption symbols.

In yet another embodiment of the present invention, a system for encrypting and retrieving a password having at least one code symbol includes an encryption device providing a slidable card having a set of index symbols; and a set of encryption symbols, wherein each set occupies a plurality of shared columns so that the set of index symbols forms one row, and the set of encryption symbols forms a plurality of countable rows; and a sleeve dimensioned and adapted to slidably receive the slidable card, wherein the sleeve forms an index window and an encryption window for reading one shared column having one index symbol and a portion of the plurality of encryption symbols; a hint sequence providing a plurality of alphanumeric symbols; an unforgettable number; and the method of mentioned above.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1;

FIG. 3 is an exploded view of an exemplary embodiment of the present invention;

FIG. 4 is a top view of an exemplary embodiment of the present invention;

FIG. 5 is a top view of an exemplary embodiment of the present invention, shown in use; and

FIG. 6 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an encryption device and method for creating, storing and retrieving passwords. The encryption device may include a sleeve for receiving a slidable card, both cooperative so that the sleeve and the slidable card are movable relative to each other. The sleeve forms an index window and an encryption window through which a portion of a set of index symbols and a portion of a set of encryption symbols imprinted on the slidable card may be respectively read. As the slidable card slides to display a new portion of the set of index symbols through the index window, a new portion of the set of encryption symbols become readable through the encryption window. The method embodying the encryption device utilizes a skip sequence number formula, a hint, and/or at least one unforgettable number to create a plurality of unique, encrypted passwords that can be similarly retrieved/decrypted with the encryption device and method when needed.

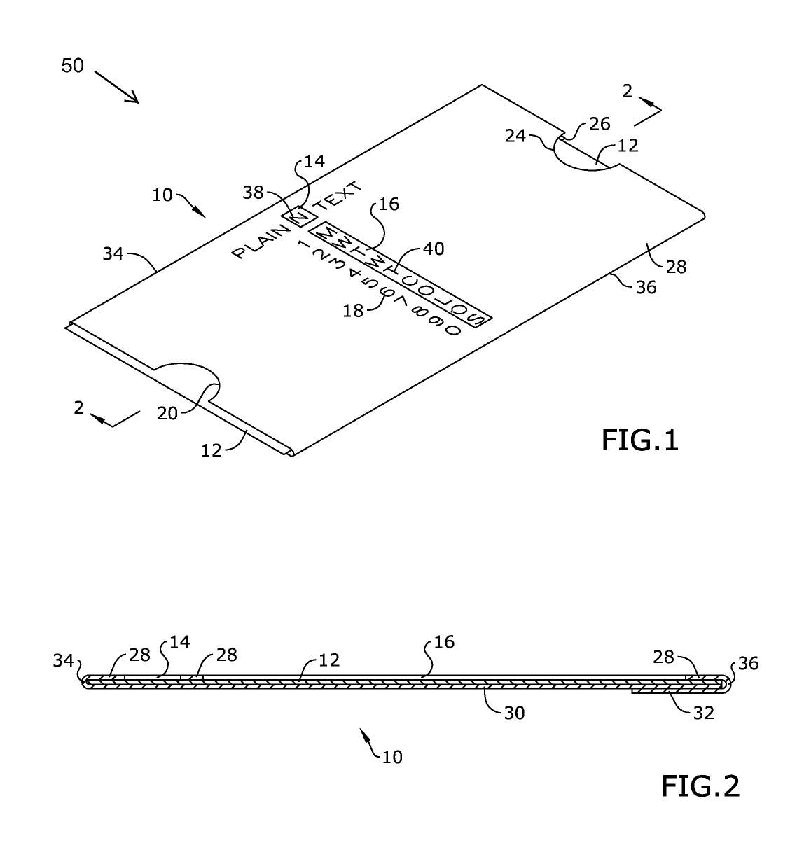

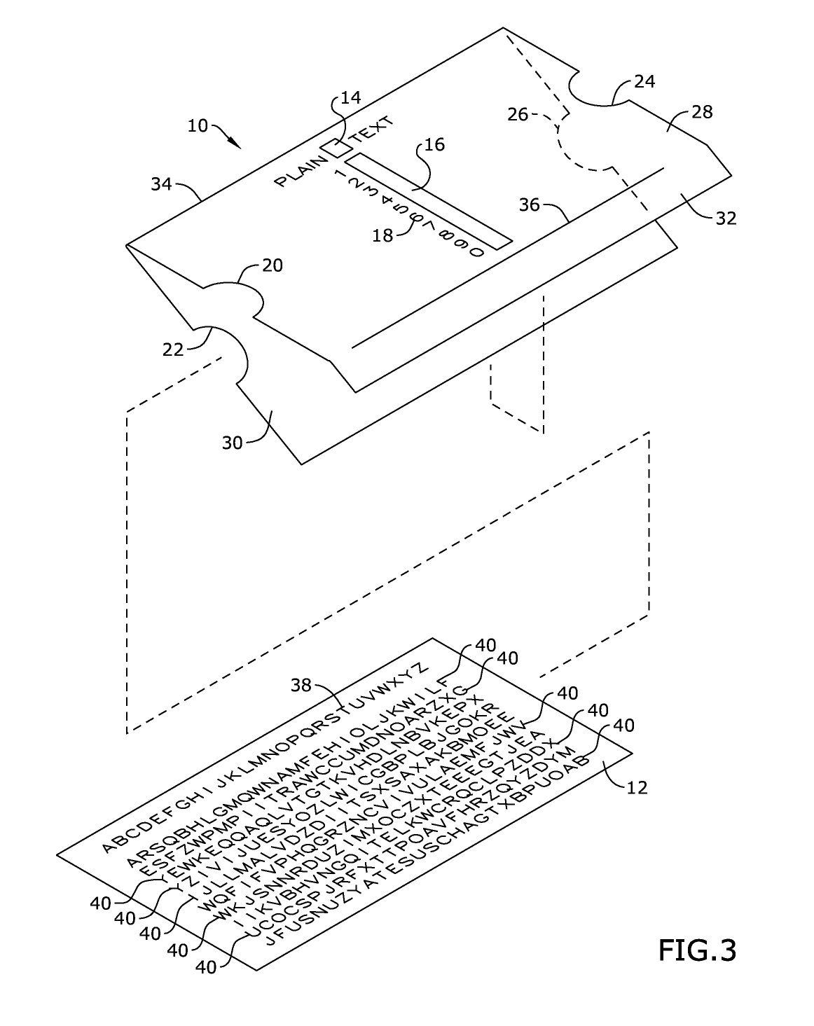

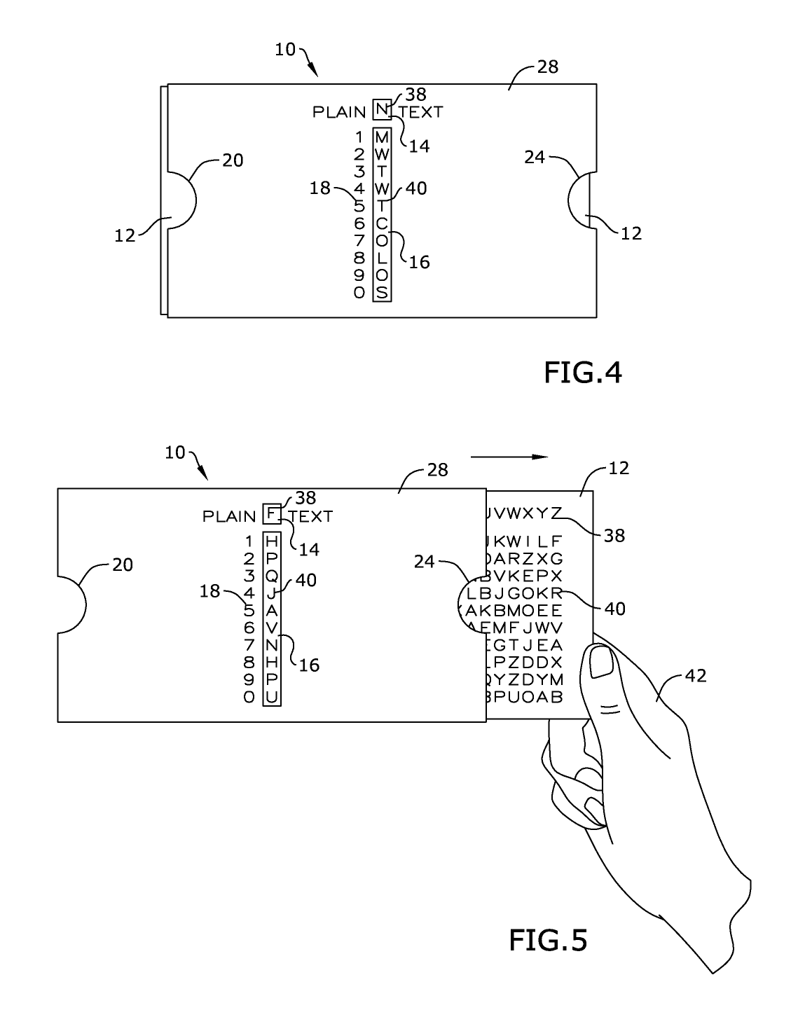

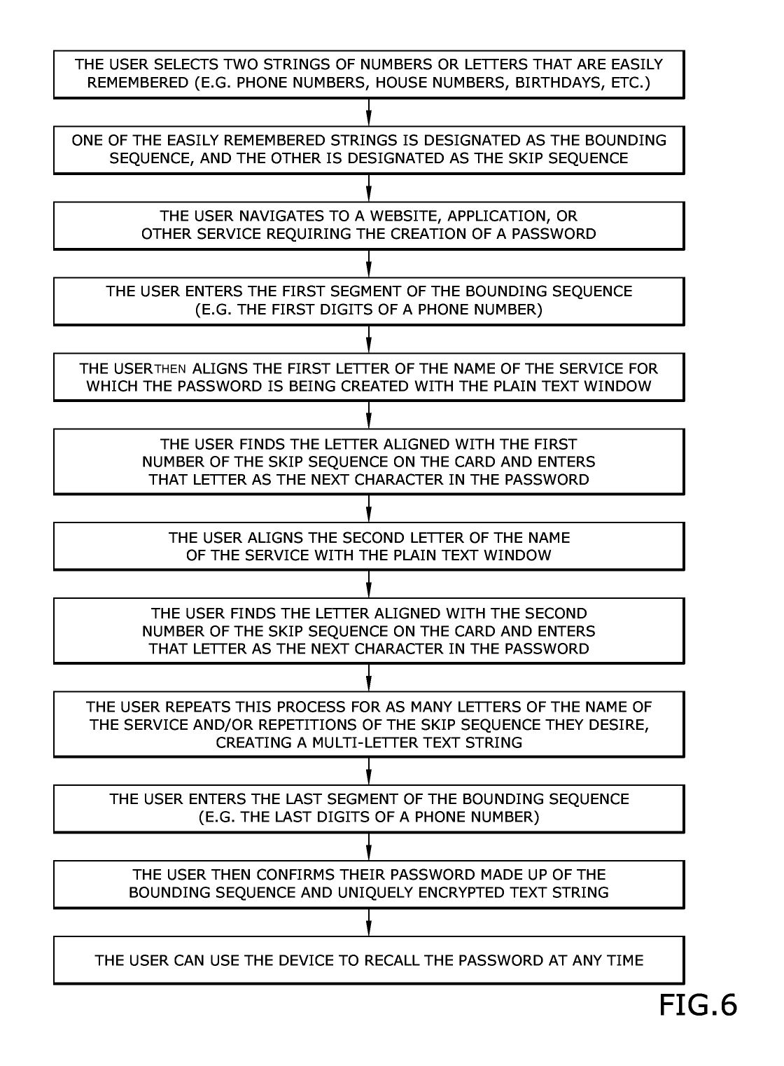

Referring to FIGS. 1 through 6, the present invention may include an encryption device 50 that embodies a method for creating, storing and retrieving passwords. The encryption device 50 may include a sleeve 12 for receiving a slidable card 10, both cooperative so that the sleeve 10 and the slidable card 12 are movable relative to each other.

The slidable card 12 may be made of paper, plastic, cardboard, card stock, plastic, thin metal, or other suitable material which allows a user to imprint or mark information on its surface. The slidable card 12 surface may provide a set of index symbols 38 and a set of encryption symbols 40. In certain embodiments, the set of index symbols 38 may be a single row of (though a plurality of columns) of alphanumeric symbols. In a preferred embodiment, the set of index symbols 38 may be sequenced from A to Z, followed by arabic numerals 0 to 9. In certain embodiments, the set of encryption symbols 40 may include a random arrangement of alphanumeric and non-alphanumeric symbols arrayed in a plurality of rows and columns, wherein the set of index symbols 38 and the set of encryption symbols 40 are predisposed so that their respective columns align.

The sleeve 10 may be a sheet with a first fold line 34 and a second fold line 36, wherein the sheet may be folded along the first fold line 34 to form a sleeve front 28 and a sleeve back 30. Moreover the sleeve front 20 may provide a sleeve flap 32, wherein the sleeve flap 32 is foldable about the second fold line 36 so as to overlap the sleeve back 30, forming the hollow sleeve with two opposing, open ends. In certain embodiment, the sleeve 10 is a unitary envelope with two open, opposing ends. The hollow sleeve 10 may be dimensioned and adapted to slidably receive the slidable card 10 through and from each opposing, open end. On each open end, the sleeve 10 may form complementary front and back thumb slots 20, 22, 24, 26 for facilitating the sliding the slidable card 12 relative to the sleeve 10.

The sleeve front 28 and/or the sleeve back 30 may form an index window 14 and/or an encrypted window 16, through which information imprinted or marked on the surface of the slidable card 12 are revealed/displayed, as illustrated in FIGS. 1, 4 and 5. In the preferred embodiment, such revealed/displayed information includes predetermined portions of the set of index symbols 38 through the index window 14 and simultaneously a column of encryption symbols 40 through the encrypted window 16. Generally, the index window 14 may be dimensioned and adapted to reveal only one (column of) index symbol 38 at a time, while the encrypted window 16 may be dimensioned and adapted so as to simultaneously reveal one column of encryption symbols 40, as illustrated in FIGS. 1, 4 and 5. In certain embodiments, the encryption window 16 may be elongated, and along its length a plurality of numeric labels 18 may be disposed, as illustrated in FIGS. 1, 4 and 5. In the preferred embodiment, there are ten sequential numeric labels 18, as illustrated in FIG. 1, so that ten separate, associated encryption symbols 40 appear alongside the ten sequential numeric labels 18.

The dimensions of the sleeve 10 should be such that it can be conveniently carried by a user 42. In the preferred embodiment, the dimensions of the sleeve 10 are approximately the dimensions of a business credit card.

The method of using the present invention may include the following. The encryption device 50 disclosed above may be provided. The encryption device 50 may be used in conjunction with a “skip sequence number” formula coupled with at least one unforgettable number for each user 42 and a hint sequence. Examples of the at least one unforgettable number would be a phone number (such as 958-1099), a house number (such as 243), a birth date, and the like. Examples of the hint sequence may be the first predetermined symbols in a website address or a series of identifiable alphanumeric symbols.

The method of creating unlimited encrypted, yet retrievable passwords is as follows. The method may be for accessing various websites, requiring and retrieval (“decryption”) of said passwords for subsequent use. Each unique, retrievable password would be comprised of a series of code symbols. The series of code system may be created by the encryption device 50 converting the hint sequence into a cooperating sequence of encryption symbols 40.

Take for example, a common web site such as facebook.com. Like almost all other websites, the word FACEBOOK would be plainly identifiable in the computer address bar, and as such is a sufficient hint sequence for the password. Next using the encryption device 50 the user 42 may encrypt at least a portion of facebook.com—the hint sequence—into the series of code symbols. The method may use only a portion of the hint sequence, for example, the first six letters, or “FACEBO”—to form at least a portion of the password. Typically, the user would start with the first letter of the hint sequence to be encrypted, and so slide the slidable card 12 relative to the sleeve 10 so that the “F” index symbol 38 is displayed through the index window 14, whereby a column of the set of encryption symbols 40 is displayed through the encryption window 16, as illustrated in FIG. 5. Specifically, there would be one symbol from the set of encryption symbols 40 adjacent to each of the ten sequential numeric labels 18, so that the user 42 may apply a mathematical formula called the “skip sequence number formula.”

The “skip sequence number” formula dictates that the user 42 use one of their unforgettable number, or “skip sequence,” to identify which specific numeric label 18 and so to identify its associated encrypted symbol 40 as the relevant code symbol to be used in forming the password. For instance, say the skip sequence/unforgettable number is the house number 243. As a result of this skip sequence, the user 42 would identify the associated encrypted symbol 40 alongside the numeric label 18 position “2” in the encryption window 16 as the first code symbol of the password. Then the user 42 may slide the index window 14 to the letter “A” (the second letter of FACEBO) and read down to position “4” entering that associated encryption symbol 40 as the second code symbol of the password. Next index letter is “C,” and its encrypted code symbol is read at position “3”.

In certain embodiments, when the three digits/numbers of “243” have been used up, the user may start the skip sequencing over for the remaining predetermined letters (E, B, and O). In this example, the encrypted value of “E” appears alongside position “2”; “B” is alongside position “4”; and the last letter “O” is read at position “3”. Thus the plain word/hint sequence “FACEBO” is converted to six gibberish letters or series of code symbols that would compose the unique password for that web site.

In an alternative embodiment, the user may ascribe one of the unforgettable numbers as a bounding sequence. For example, their telephonic number 958-1099. At the sign-in password box the user 42 would enter 958 (the first 3 digits of the memorable telephonic phone number). And then at the last step, the user 42 would enter in the password box the remainder of the phone number/bounding sequence “1099”. So for the case of facebook.com example from above, the resulting password would be 13 characters long and look something like this (958??????1099) where “??????” would be the encryption device 50 encrypted code symbols.

It should be understood, of course, that the foregoing relates to exemplary embodiments of the invention and that modifications may be made without departing from the spirit and scope of the invention as set forth in the following claims.

What is claimed is:

1. A method for encrypting and retrieving a password having at least one code symbol, comprising the steps of:
providing a set of index symbols and a set of encryption symbols, wherein each set occupies a plurality of columns, and wherein each set includes at least alphanumeric symbols;
aligning the set of index symbols and the set of encryption symbols in shared columns, wherein the set of index symbols forms one row, and the set of encryption symbols forms a plurality of countable rows;
identifying a hint sequence comprising a plurality of alphanumeric symbols;
providing an unforgettable number having a predetermined number of digits;
locating a first column of the set of index symbols matching the alphanumeric symbol of a first symbol of the hint sequence; and
identifying as a first code symbol a first symbol from the set of encryption symbols found in the first column and the countable row referenced by counting corresponding to a first digit of the unforgettable number.

2. The method of claim 1, further comprising the step of locating a second column of the set of index symbols matching the alphanumeric symbol of a second symbol of the hint sequence; and
identifying as a second code symbol a second symbol from the set of encryption symbols found in the second column and the countable row referenced by counting corresponding to a second digit of the unforgettable number.

3. The method of claim 1, further comprising the step of displaying the set of index symbols and the set of encryption symbols on a slidable card.

4. The method of claim 4, further comprising the step of providing a sleeve dimensioned and adapted to slidably receive the slidable card, wherein the sleeve forms an index window and encryption window for reading the located column sharing one index symbol and a portion of the plurality of encryption symbols.

5. The method of claim 2, further comprising the step of skipping back to the first digit of the unforgettable number for identifying a subsequent code symbol when the number of alphanumeric symbols of the hint sequence exceeds the predetermined number of digits of the unforgettable number.

6. The method of claim 1, further comprising the step of providing a bounding sequence, wherein a first portion of the bounding sequence is added to the beginning of the password, and wherein a second portion of the bounding sequence is added to the end of the password.

7. An encryption device for encrypting and retrieving a password having at least one code symbol, comprising:
a slidable card comprising:
a set of index symbols; and
a set of encryption symbols, wherein each set occupies a plurality of shared columns so that the set of index symbols forms one row, and the set of encryption symbols forms a plurality of countable rows; and
a sleeve dimensioned and adapted to slidably receive the slidable card, wherein the sleeve forms an index window and an encryption window for reading one shared column comprising one index symbol and a portion of the plurality of encryption symbols.

8. The encryption device of claim 7, wherein the sleeve further comprises a plurality of numeric labels disposed alongside the encryption window.

9. The encryption device of claim 8, wherein the plurality of numeric labels consist of the arabic numeral 0 to 9.

10. A system for encrypting and retrieving a password having at least one code symbol, comprising:
an encryption device comprising:
a slidable card comprising:
a set of index symbols; and
a set of encryption symbols, wherein each set occupies a plurality of shared columns so that the set of index symbols forms one row, and the set of encryption symbols forms a plurality of countable rows; and
a sleeve dimensioned and adapted to slidably receive the slidable card, wherein the sleeve forms an index window and an encryption window for reading one shared column comprising one index symbol and a portion of the plurality of encryption symbols;
a hint sequence comprising a plurality of alphanumeric symbols;
an unforgettable number; and
the method of claim 2.
